(19) United States
(12) Patent Application Publication
(10) Pub. No.: US 2012/0330865 A1
(43) Pub. Date: Dec. 27, 2012

(54) SYSTEM AND METHOD FOR FORMULATING A PROBLEM

(76) Inventor: Dhiraj Rajaram, Northbrook, IL (US)

(21) Appl. No.: 13/166,251

(22) Filed: Jun. 22, 2011

(51) Int. Cl. G06F 15/18

(52) U.S. Cl. 706/12

(57) ABSTRACT

A method for formulating a problem using a computational system is provided. The method includes determining an initial problem statement that characterizes the problem and identifying a plurality of factors affecting the problem. The method also includes generating a plurality of hypotheses associated with the problem based upon the identified factors and updating the initial problem statement to an updated problem statement using the initial problem statement, identified factors and the plurality of hypotheses.

### BACKGROUND

The invention relates generally to business problems, and particularly to a systems and methods for formulating problem statements for such problems.

Business enterprises must address issues or problems related to the business in a systematic and efficient manner. Effectively addressing the issues presented by such situations requires determination of the exact issues to be acted upon. Understanding and defining the problem is a useful first step in the solution process of the problem. This requires defining of the problem, finding and analyzing information and developing course of action to address the problem.

Most of the existing problems solving techniques are focused towards utilizing different techniques for analyzing the data related to the problem and determining an appropriate solution to the problem. Unfortunately, in some cases the problem statement itself is not representative of the entire problem and may change based upon a variety of parameters affecting the problem. Such problem statements when analyzed may not provide an efficient solution to the problem. Moreover, extra time and effort may be required to solve the problem using such problem definitions.

In certain complex situations, the main problem may be masked by other problems that are more apparent thus making it difficult to define the problem statement. It is required that the problem statement characterizes the main problem and the relevant sub-problems to provide an efficient and effective solution.

Therefore, it is desirable to develop a robust problem statement characterizing the problem that can be analyzed to solve the problem effectively and efficiently.

### BRIEF DESCRIPTION

Briefly, according to one embodiment of the present invention, a method for formulating a problem using a computational system is provided. The method includes determining an initial problem statement that characterizes the problem and identifying a plurality of factors affecting the problem. The method also includes generating a plurality of hypotheses associated with the problem based upon the identified factors and updating the initial problem statement to an updated problem statement using the initial problem statement, identified factors and the plurality of hypotheses.

In another embodiment, a system for formulating a problem is provided. The system includes a user interface for providing input data associated with the problem and memory circuitry configured to store the input data. The system also includes processing circuitry configured to access the memory circuitry. The processing circuitry includes a definer module configured to define an initial problem statement using the input data and to represent the initial problem statement using a current state of the problem, a desired solution of the problem and gaps between the current state and the desired solution of the problem. The processing circuitry further includes an analysis module configured to identify a plurality of factors that affect the problem and to generate a plurality of hypotheses based upon the identified factors.

In another embodiment, a method for formulating a problem using a computational system is provided. The method includes determining an initial problem statement that characterizes the problem based upon input data associated with the problem and representing the initial problem statement using a current state of the problem, a desired solution of the problem and gaps between the current state and the desired solution of the problem. The method also includes identifying a plurality of factors affecting the problem using the initial problem statement and generating a plurality of hypotheses associated with the problem based upon the identified factors and the input data. The method further includes determining a plurality of associated component questions corresponding to each of the plurality of hypotheses and identifying a plurality of data elements associated with the component questions, validating each of the plurality of hypotheses through pre-determined hypothesis validation tests using the data elements and iteratively updating the initial problem statement to an updated problem statement using the initial problem statement, identified factors and the plurality of hypotheses.

### DRAWINGS

These and other features, aspects, and advantages of the present invention will become better understood when the following detailed description is read with reference to the accompanying drawings in which like characters represent like parts throughout the drawings, wherein:

FIG. 1 is an example flow diagram of an embodiment of a method for formulating a problem using a computational system;

FIG. 2 is a schematic diagram of a system for formulating a problem statement in accordance with aspects of the present technique;

FIG. 3 shows an exemplary home screen of the system of FIG. 2 in accordance with aspects of the present technique;

FIG. 4 shows an exemplary problem definition screen of the system of FIG. 2 in accordance with aspects of the present technique;

FIG. 5 shows an exemplary factor map screen of the system of FIG. 2 in accordance with aspects of the present technique;

FIG. 6 shows an exemplary hypothesis matrix screen of the system of FIG. 2 in accordance with aspects of the present technique;

FIG. 7 shows an exemplary explorer screen of the system of FIG. 2 in accordance with aspects of the present technique;

FIG. 8 shows an exemplary version control screen of the system of FIG. 2 in accordance with aspects of the present technique; and

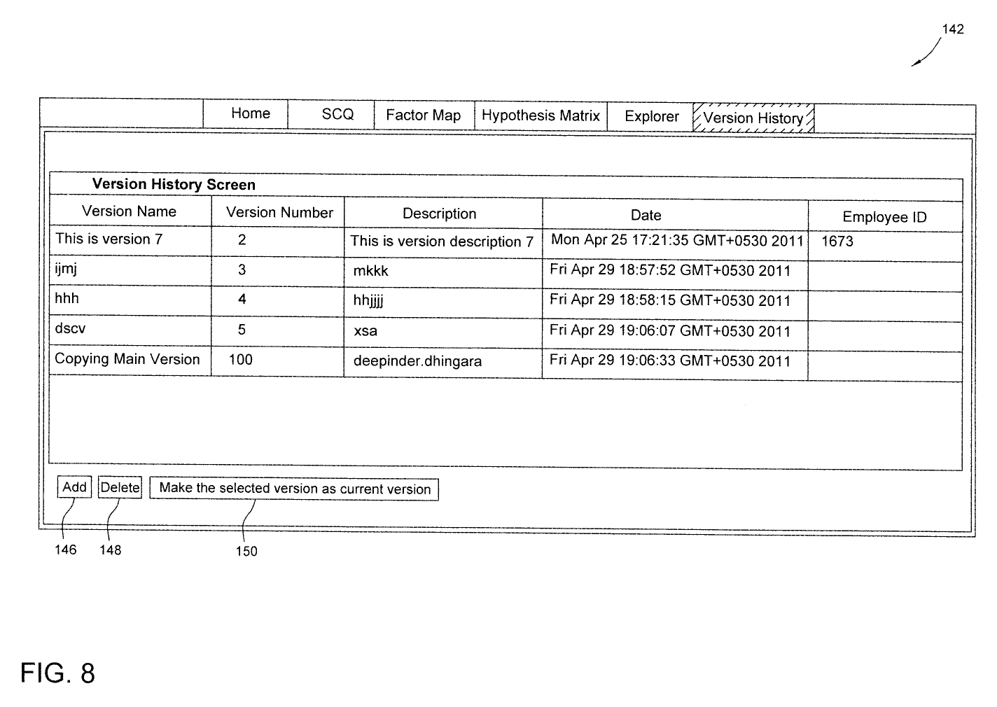

FIG. 9 is a block diagram illustrating an exemplary computing device that is arranged for formulating a problem in accordance with aspects of the present technique.

### DETAILED DESCRIPTION

As discussed in detail below, the embodiments of the present invention function to provide a system and method for formulating and representing a problem statement characterizing a business problem, for example. In particular, the present technique facilitates representation of the business problem by an initial problem statement using a current state of the problem, a desired solution of the problem and gaps between the current state and the desired solution. Moreover, the embodiments of the present invention provide a technique for updating the initial problem statement using factors affecting the problem and a plurality of hypotheses associated with the problem.

References in the specification to “one embodiment”, “an embodiment”, “an exemplary embodiment”, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

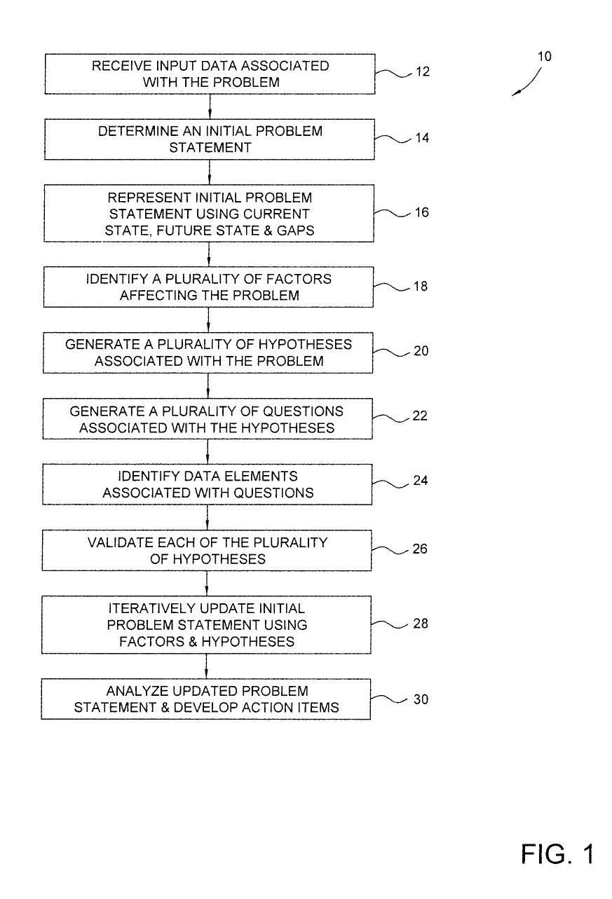

Turning now to drawings and referring first to FIG. 1, an example flow diagram 10 of an embodiment of a method for formulating a problem using a computational system is illustrated. The problem may include a variety of business problems experienced by organizations, for example. However, a variety of other problems in different environments may be formulated in a similar way. At block 12, input data associated with the problem is received. The input data may include details of the problem to be formulated and analyzed for achieving a desired solution. The input data may also include possible factors and conditions affecting the problem. In certain embodiments, such input data may be obtained from people/systems associated with the respective operating environment via a variety of data collection mechanisms such as surveys, assessments and so forth.

Moreover, an initial problem statement characterizing the problem is determined based upon the input data, as represented by block 14. In this exemplary embodiment, the initial problem statement is defined by analyzing the input data to determine the current state of the problem along with a future desired state. Moreover, gaps and trigger events are identified to define the initial problem statement. In certain embodiments, a survey or assessment related to the gaps between the current state and the desired solution is conducted for defining the initial problem statement. The survey or assessment may be conducted using a plurality of questions related to the problem to collect information for defining the initial problem statement.

At block 16, the initial problem statement is represented using a current state of the problem, a desired solution of the problem and gaps between the current state and the desired solution of the problem. Such representation facilitates clarity of the problem definition. At block 18, a plurality of factors affecting the problem are identified using the initial problem statement. The factors may be obtained using various data sources. In one embodiment, an exhaustive list of factors is obtained as inputs from a group of people such as business clients or other users affected by the problem and associated with the respective business environment. Moreover, one or more factors may be identified or updated based upon responses to the plurality of questions.

In this exemplary embodiment, each of the identified factors is assigned to one or more factor categories and attributes corresponding to each of the factor categories are determined. As will be appreciated by one skilled in the art, the number and types of the factor categories may be pre-determined and such factor categories may be periodically updated.

Furthermore, a plurality of hypotheses associated with the problem are generated based upon the identified factors and the input data, as represented by block 20. In this exemplary embodiment, the plurality of hypotheses include mutually exclusive and completely exhaustive (MECE) hypotheses. In one exemplary embodiment, exploratory data analysis (EDA) is performed to generate the plurality of hypotheses. For example trend analysis of the data may be performed to generate the hypotheses. At block 22, a plurality of associated component questions corresponding to each of the plurality of hypotheses are determined. A plurality of data elements associated with the component questions are also identified, as represented by block 24.

At block 26, each of the plurality of hypotheses is validated via pre-determined hypothesis tests using the data elements. In one exemplary embodiment, the hypotheses may be classified and assigned priority levels. The validation of the hypotheses may be performed in accordance with the assigned priority levels. In another embodiment, the data elements may be classified into various categories and selected data elements are utilized for validating the hypotheses. The data elements may be selected based upon availability and/or accessibility of the data, an estimated analytical effort and effectiveness of the data elements in solving the problem.

The initial problem statement is iteratively updated using the initial problem statement, identified factors and the plurality of hypotheses to form an updated problem statement, as represented by block 28. It should be noted that the updated problem statement is represented in a format similar to the initial problem statement. At block 30, the updated problem statement is analyzed and action items are developed to address the problem and to achieve the desired solution of the problem.

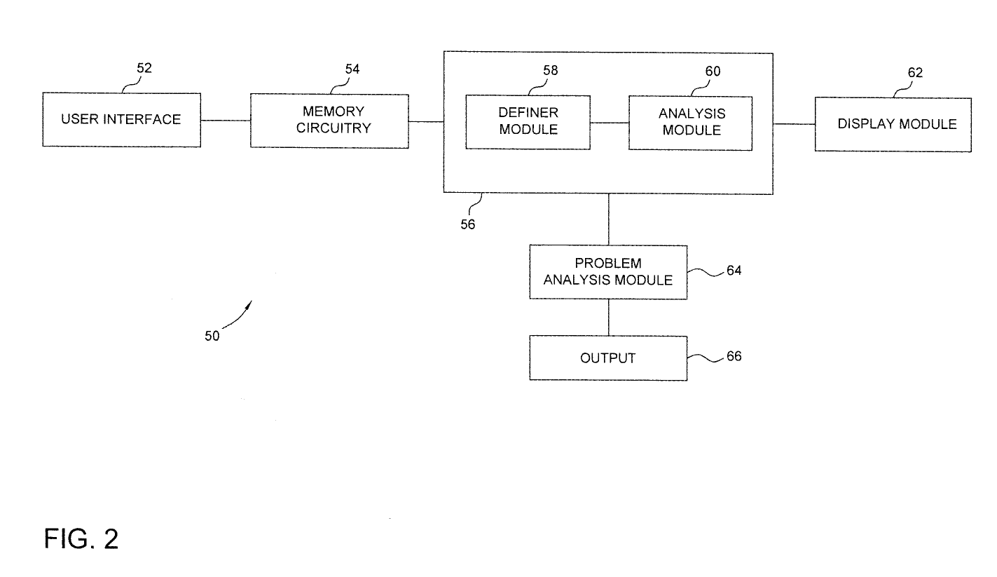

FIG. 2 is a schematic diagram of a system 50 for formulating a problem statement. The system 50 includes a user interface 52 for providing input data associated with the problem. The user interface 52 may be accessed by users, system administrators and computer programmers for providing the input data. Examples of input data include, but are not limited to, parameters related to current state of the problem and a future desired solution of the problem, details regarding objectives of all stake holders associated with the problem, details of data required for formulating the problem statement, version details of the problem formulation and details of users accessing the system.

The system 50 further includes a memory circuitry 54 for storing the input data. The memory circuitry 54 may include hard disk drives, optical drives, tape drives, random access memory (RAM), read-only memory (ROM), programmable read-only memory (PROM), Redundant Arrays of Independent Disks (RAID), flash memory, magneto-optical memory, holographic memory, bubble memory, magnetic drum, memory stick, Mylar® tape, smartdisk, thin film memory, zip drive, and so forth.

In addition, the system 50 includes a processing circuitry 56 configured to access the memory circuitry 54 for processing the input data and to formulate the problem statement. As illustrated, the processing circuitry 56 includes a definer module 58 and an analysis module 60. The definer module 58 is configured to define an initial problem statement using the input data. The initial problem statement is represented using a current state of the problem, a desired solution of the problem and gaps between the current state and the desired solution of the problem.

The analysis module 60 is configured to identify a plurality of factors that affect the problem and to generate a plurality of hypotheses based upon the identified factors. The identified factors and the plurality of hypotheses may be stored in the memory circuitry 54. In certain embodiments, hypotheses are designed around one or more key stakeholders associated with the business problem. It should be noted that the memory circuitry 54 functions as a repository of different parameters related to the problem such as the input data, the factors and the hypotheses and such parameters can be accessed from time-to-time by the users of the system 50.

The processing circuitry 56 is configured to iteratively update the initial problem statement using the identified factors and the hypotheses to generate an updated problem statement. In this exemplary embodiment, the analysis module 60 generates a plurality of component questions corresponding to each of the plurality of hypotheses and identifies data elements associated with the component questions. Moreover, the responses to the component questions and the corresponding data elements are utilized to generate the updated problem statement. The analysis module 60 is further configured to validate each of the plurality of hypotheses using pre-determined hypothesis validation tests.

The system 50 also includes a display module 62 to display the initial problem statement, the identified factors, the hypotheses and the updated problem statement. The system 50 may also include a problem analysis module 64 to analyze the updated problem statement and to develop action items to achieve the desired solution of the problem. The results of the analysis may be available to the users of the system 50 via output 66.

Further, the system 50 may include a variety of software and hardware for formulating the problem statement. For example, the system 50 may include file servers, application servers, web servers, disk servers, database servers, transaction servers, telnet servers, proxy servers, list servers, groupware servers, File Transfer Protocol (FTP) servers, audio/video servers, LAN servers, DNS servers, firewalls, and so forth.

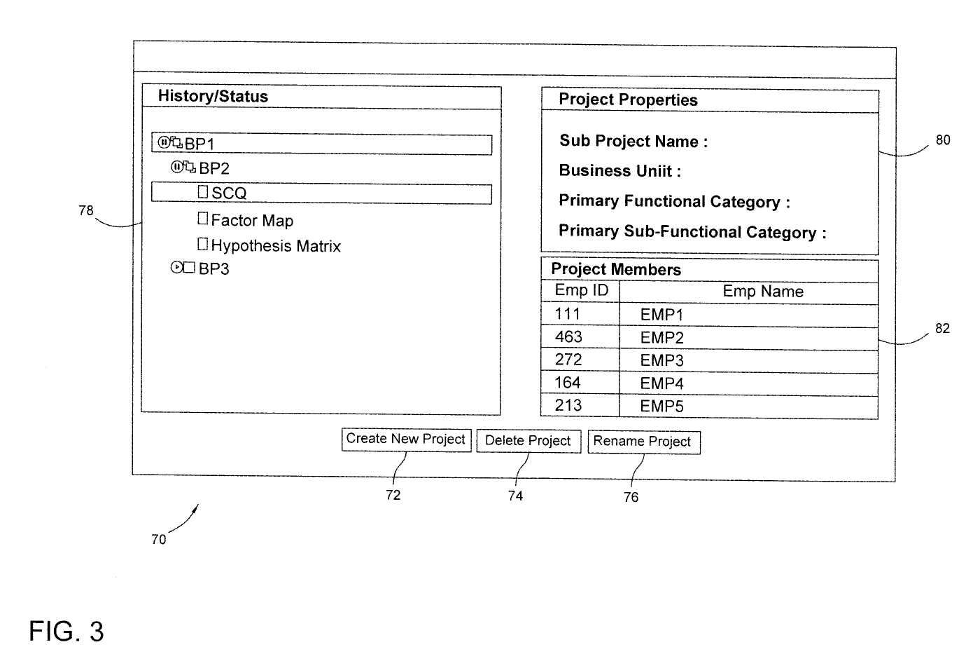

FIG. 3 shows an exemplary home screen 70 of the system 50 of FIG. 2. In this exemplary embodiment, the system 50 provides secured access to the users by authenticating unique user names and corresponding passwords assigned to each user of the system 50. The home screen 70 allows the users to create new projects, delete existing projects, or rename existing projects, as represented by reference numerals 72, 74 and 76. However, other project management options may be available.

The available projects such as represented by BP1, BP2 and BP3 for problem formulation are displayed in cell 78 of the home screen 70. Each of these projects (e.g., BP2) can be expanded to see the underlying components such as the problem statement (represented as situation-complication-question (SCQ)), a factor map including a plurality of factors affecting the problem and a hypothesis matrix including a plurality of hypotheses associated with the problem. Moreover, other relevant project details such as sub project names, business units, details of the users may be entered using cells 80 and 82. The home screen 70 may be further customized to include other categories based upon the project requirements.

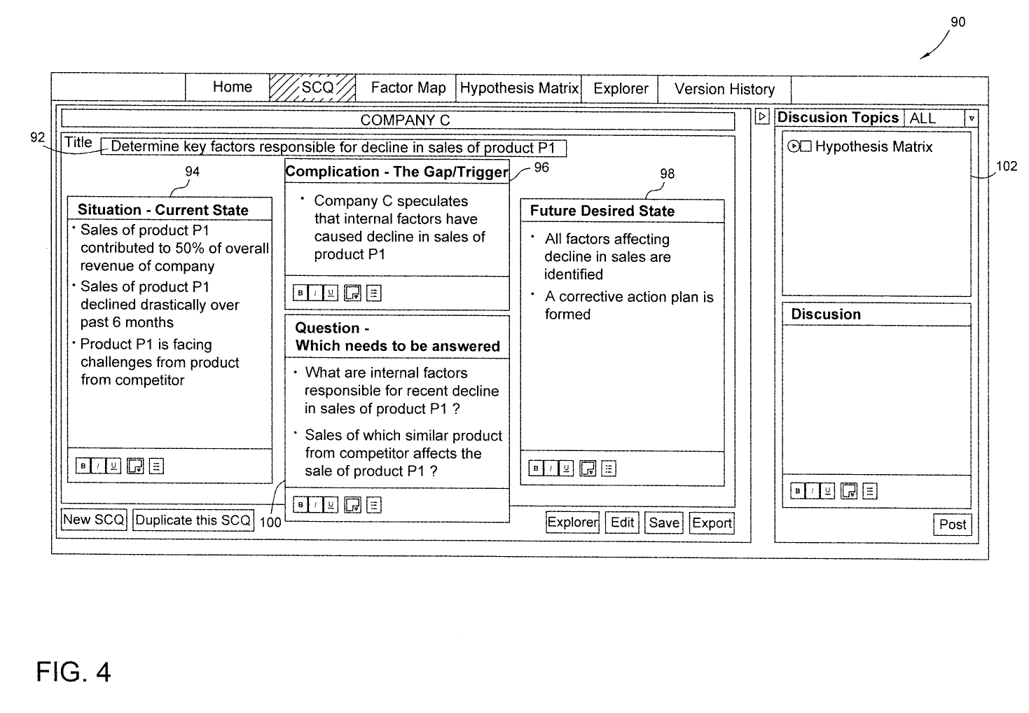

FIG. 4 shows an exemplary problem definition screen 90 of the system 50. A title of the project may be provided, as represented in cell 92. As described before, the initial problem statement is represented using a current state of the problem (cell 94), a desired solution or future desired state (cell 96) and gaps (cell 98) between the current state of the problem and the desired solution of the problem. The screen 90 enables the users to enter a plurality of questions (cell 100) related to the gaps between the current state and the desired solution of the problem that are required to be answered to achieve the desired solution.

In this exemplary embodiment, the screen 90 shows the details for a project related to decline in sales of a particular product P1 of a company C. The cell 94 includes known facts related to the situation or current state of the problem such as “sales of product P1 over the past 5 years contributed to about 50% of the overall revenue of the company”, “the sales of the product P1 has declined drastically over the past 6 months” and “the product P1 is facing some challenges from a similar product from a competitor X”, and so forth. Such known facts are representation of the current state of the problem.

Moreover, the cell 96 includes the details of the gaps/complication such as “the company C speculates that there are other internal factors that have caused the decline in sales of the product P1 in the market”. The facts related to the future desired state are listed in cell 98. For example, in the current project, it is expected that “all factors (internal and external) affecting the decline in sales are identified”. Moreover, “a corrective action plan with definite and measurable action items is formed to address the decline of the product sales”.

Moreover, the questions (cell 100) related to the gaps in this example include questions like “what are the internal factors responsible for the recent decline in the sales of the product P1” and “sales of which similar products from competitors affect the sales of the product P1”. As will be appreciated by one skilled in the art, a variety of other questions may be formulated in the problem definition phase. The screen 90 also includes a discussion cell 102 provided to facilitate discussions, or brain storming sessions related to one or more topics among the users of the system 50.

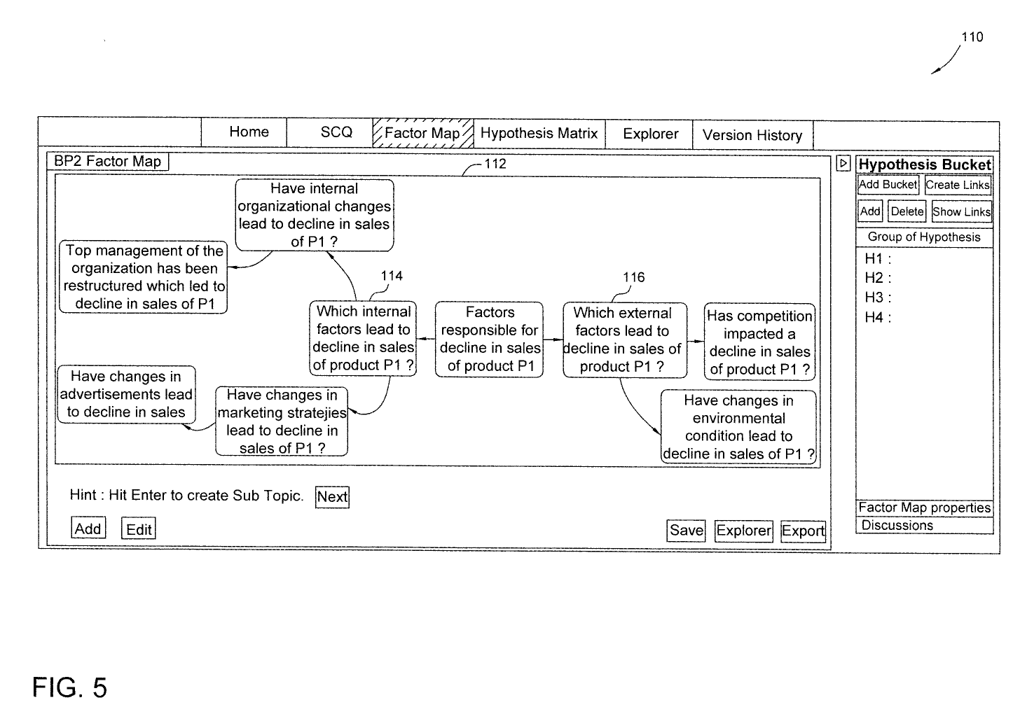

FIG. 5 shows an exemplary factor map screen 110 of the system 50. In the illustrated embodiment, the cell includes a plurality of factors 112 affecting the problem. These factors may be identified by the users of the system 50. In the present example, the factors are categorized into internal 114 and external 116 factors. For example, the internal factors include internal organizational changes, changes in quality control processes of the product, changes in the marketing strategies and so forth. Moreover, the external factors include affect of competitors products on the sale of product P1, changes in the environmental conditions etc. An exhaustive list of factors may be created by facilitating free thinking of the users and the stake holders. Such list of factors may be updated on a regular or a periodic basis.

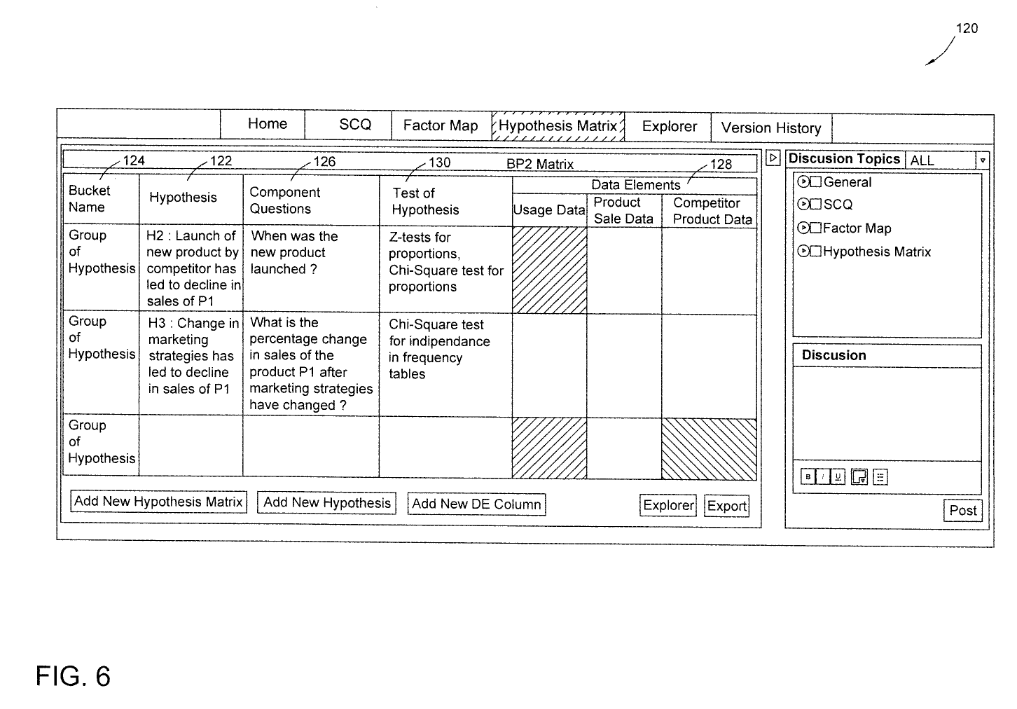

FIG. 6 shows an exemplary hypothesis matrix screen 120 of the system 50. In the illustrated embodiment, cell 122 includes a plurality of hypotheses related to the problem. Referring back to the previous example, the plurality of hypotheses may include hypotheses such as “launch of new product by competitor has led to decline in sales of product P1”, “change in marketing strategies has led to decline in sales of product P1”, among others. Each of these hypotheses may be assigned to a pre-determined category, as represented by cell 124. In a presently contemplated configuration, the hypotheses include mutually exclusive and completely exhaustive (MECE) hypotheses.

Moreover, one or more associated questions are formulated corresponding to each of the plurality of hypotheses and data elements associated with the component questions are identified (cells 126 and 128). Example component questions corresponding to the example hypotheses include “when was the new product launched” and “what is the percentage change in sales of the product P1 after the marketing strategies have changed”. Such questions may be provided to the system by users affected by the business problem, programmers and system administrators.

In the illustrated embodiment, pre-determined hypothesis validation tests (cell 130) are assigned to each of the plurality of hypotheses. Such validation tests are utilized for testing the hypotheses. Example hypothesis validation tests include, but are not limited to, Z-hypothesis validation test, Chi-square validation test and F validation test. These tests may be pre-defined by users of the system. Moreover, cell 128 includes data elements corresponding to the component questions. The data elements are utilized for validating the plurality of hypotheses. For example, the data elements corresponding to the hypotheses described above may include product usage data, product sales data, competitor product data and so forth.

In certain embodiments, the data elements may be categorized and color-coded based upon accessibility and/or availability of the data. Such data elements may be prioritized and collected based upon assigned priority levels. Similarly, the hypotheses may also be assigned priority levels by the users of the system. In this exemplary embodiment, the screen 120 may include an additional cell (not shown) for assigning the priority levels to the hypotheses.

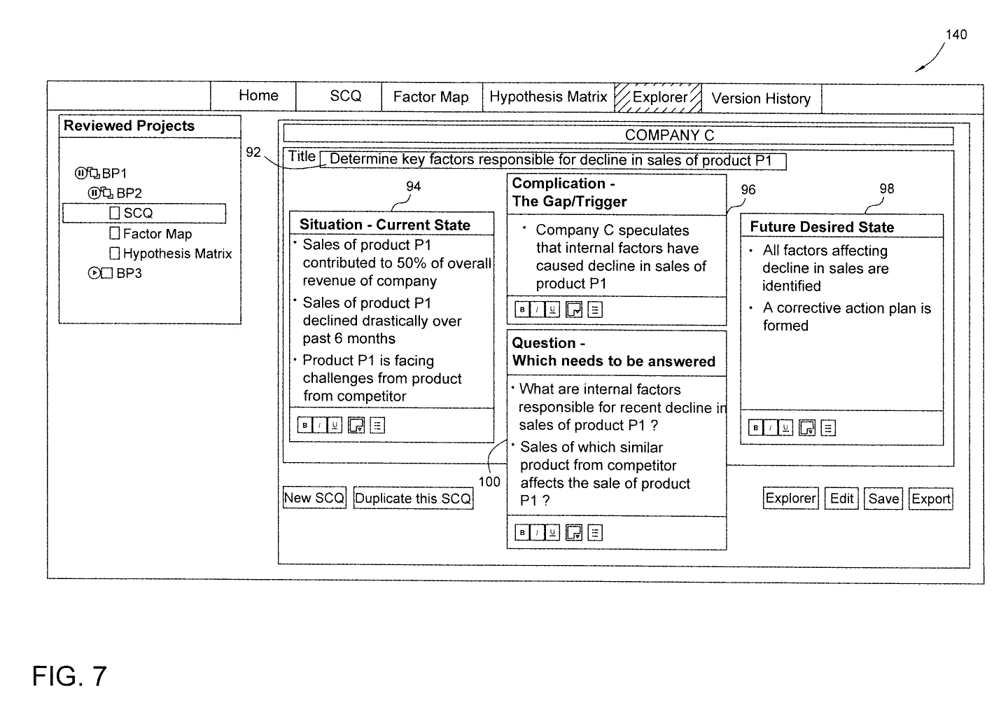

The system may include additional screens based upon the requirements of the users and/or other stake holders. For example, the system 50 may include explorer 140 and version control 142 screens (FIGS. 7 & 8) for reviewing the data and to control different versions of the projects. The explorer screen 140 may be utilized to explore the different screens of the system. Moreover, the version control screen 142 may be utilized to view the version details of the problem formulation steps and to manage the different versions of the updates by the users of the system. For example, options 146 and 148 may be utilized to add or delete selected versions of the problem formulation and cell 150 may be employed for specifying a selected version to be used as the current version.

The example methods and systems described above enable effective and reliable formulation of a problem statement. The methods and systems discussed herein utilize an efficient, robust and reliable technique for formulating the problem statement using factors affecting the problem and hypotheses associated with the problem.

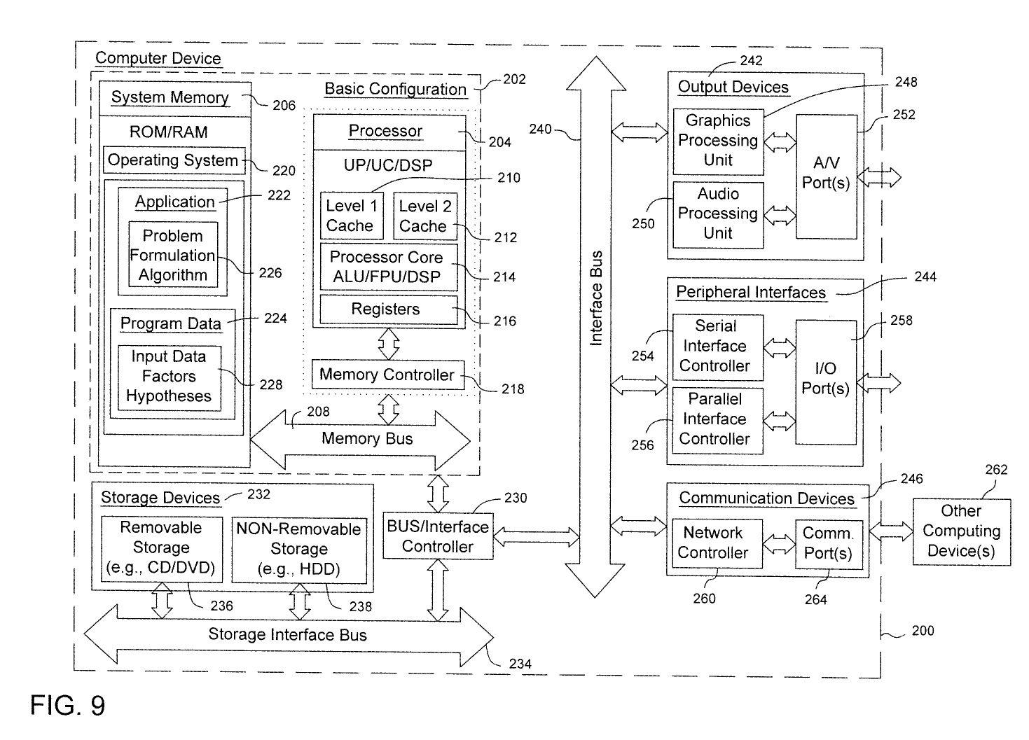

FIG. 9 is a block diagram illustrating an example computing device 200 that is arranged for formulating a problem statement in accordance with the present disclosure. In a very basic configuration 202, computing device 200 typically includes one or more processors 204 and a system memory 206. A memory bus 208 may be used for communicating between processor 204 and system memory 206.

Depending on the desired configuration, processor 204 may be of any type including but not limited to a microprocessor (μP), a microcontroller (μC), a digital signal processor (DSP), or any combination thereof. Processor 204 may include one more levels of caching, such as a level one cache 210 and a level two cache 212, a processor core 214, and registers 216. An example processor core 214 may include an arithmetic logic unit (ALU), a floating point unit (FPU), a digital signal processing core (DSP Core), or any combination thereof. An example memory controller 218 may also be used with processor 204, or in some implementations memory controller 218 may be an internal part of processor 204.

Depending on the desired configuration, system memory 206 may be of any type including but not limited to volatile memory (such as RAM), non-volatile memory (such as ROM, flash memory, etc.) or any combination thereof. System memory 206 may include an operating system 220, one or more applications 222, and program data 224. Application 222 may include a problem formulation algorithm 226 that is arranged to perform the functions as described herein including those described with respect to process 10 of FIG. 1. Program data 224 may include input data, factors affecting the problem and hypotheses as is described herein. In some embodiments, application 222 may be arranged to operate with program data 224 on operating system 220 such that formulation of the problem statement may be performed. This described basic configuration 202 is illustrated in FIG. 9 by those components within the inner dashed line.

Computing device 200 may have additional features or functionality, and additional interfaces to facilitate communications between basic configuration 202 and any required devices and interfaces. For example, a bus/interface controller 230 may be used to facilitate communications between basic configuration 202 and one or more data storage devices 232 via a storage interface bus 234. Data storage devices 232 may be removable storage devices 236, non-removable storage devices 238, or a combination thereof.

Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 206, removable storage devices 236 and non-removable storage devices 238 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 200. Any such computer storage media may be part of computing device 200.

Computing device 200 may also include an interface bus 240 for facilitating communication from various interface devices (e.g., output devices 242, peripheral interfaces 244, and communication devices 246) to basic configuration 202 via bus/interface controller 230. Example output devices 242 include a graphics processing unit 248 and an audio processing unit 250, which may be configured to communicate to various external devices such as a display or speakers via one or more A/V ports 252.

Example peripheral interfaces 244 include a serial interface controller 254 or a parallel interface controller 256, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 246 includes a network controller 260, which may be arranged to facilitate communications with one or more other computing devices 262 over a network communication link via one or more communication ports 264.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 200 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 200 may also be implemented as a personal computer including both laptop computer and non-laptop computer configurations.

As will be appreciated by those of ordinary skill in the art, the foregoing example, demonstrations, and process steps may be implemented by suitable code on a processor-based system. It should also be noted that different implementations of the present technique may perform some or all of the steps described herein in different orders or substantially concurrently, that is, in parallel. Furthermore, the functions may be implemented in a variety of programming languages, such as C++ or JAVA. Such code, as will be appreciated by those of ordinary skill in the art, may be stored or adapted for storage on one or more tangible, machine readable media, such as on memory chips, local or remote hard disks, optical disks (that is, CDs or DVDs), or other media, which may be accessed by a processor-based system to execute the stored code.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for formulating a problem using a computational system, the method comprising:
determining an initial problem statement that characterizes the problem;
identifying a plurality of factors affecting the problem;
generating a plurality of hypotheses associated with the problem based upon the identified factors;
updating the initial problem statement to an updated problem statement using the initial problem statement, identified factors and the plurality of hypotheses.

2. The method for formulating a problem of claim 1, further comprising representing the initial and updated problem statements using a current state of the problem, a desired solution of the problem, gaps between the current state and the desired solution, and combinations thereof.

3. The method for formulating a problem of claim 2, further comprising:
conducting a survey/assessment related to the gaps between the current state and the desired solution; and
identifying and/or updating at least one of the plurality of factors and the plurality of hypotheses based upon corresponding responses to the survey/assessment.

4. The method for formulating a problem of claim 1, further comprising assigning each of the identified factors to one or more factor categories and determining attributes corresponding to each of the pre-determined factor categories.

5. The method for formulating a problem of claim 1, wherein the plurality of hypotheses comprise mutually exclusive and completely exhaustive (MECE) hypotheses.

6. The method for formulating a problem of claim 1, wherein generating the plurality of hypotheses comprises determining a plurality of associated component questions corresponding to each of the plurality of hypotheses and identifying a plurality of data elements associated with the component questions.

7. The method for formulating a problem of claim 6, further comprising classifying the plurality of data elements based upon availability and/or accessibility of data corresponding to the data elements.

8. The method for formulating a problem of claim 7, further comprising prioritizing the analysis of the plurality of component questions based upon the availability and/or accessibility of the data.

9. The method for formulating a problem of claim 6, further comprising assigning a hypothesis validation test to each of the plurality of hypotheses.

10. The method for formulating a problem of claim 1, wherein updating the initial problem statement comprises iteratively updating the initial problem statement using the factors and the plurality of hypotheses.

11. A system for formulating a problem, the system comprising:
a user interface for providing input data associated with the problem;
memory circuitry configured to store the input data; and
processing circuitry configured to access the memory circuitry, wherein the processing circuitry comprises:
a definer module configured to define an initial problem statement using the input data and to represent the initial problem statement using a current state of the problem, a desired solution of the problem and gaps between the current state and the desired solution of the problem; and
an analysis module configured to identify a plurality of factors that affect the problem and to generate a plurality of hypotheses based upon the identified factors.

12. The system of claim 11, wherein the memory circuitry is configured to store the identified factors and the plurality of hypotheses.

13. The system of claim 11, wherein the processing circuitry is configured to iteratively update the initial problem statement using the identified factors and the hypotheses to generate an updated problem statement.

14. The system of claim 13, wherein the analysis module is further configured to generate a plurality of component questions corresponding to each of the plurality of hypotheses and identify a plurality of data elements associated with the component questions, wherein the responses to the component questions and the corresponding data elements are utilized to generate the updated problem statement.

15. The system of claim 11, wherein the analysis module is configured to validate each of the plurality of hypotheses using pre-determined hypothesis validation tests.

16. The system of claim 11, further comprising a display module to display the initial problem statement, the identified factors, the hypotheses and the updated problem statement.

17. A method for formulating a problem using a computational system, the method comprising:
determining an initial problem statement that characterizes the problem based upon input data associated with the problem;
representing the initial problem statement using a current state of the problem, a desired solution of the problem and gaps between the current state and the desired solution of the problem;
identifying a plurality of factors affecting the problem using the initial problem statement;
generating a plurality of hypotheses associated with the problem based upon the identified factors and the input data;
determining a plurality of associated component questions corresponding to each of the plurality of hypotheses and identifying a plurality of data elements associated with the component questions;
validating each of the plurality of hypotheses through pre-determined hypothesis validation tests using the data elements; and
iteratively updating the initial problem statement to an updated problem statement using the initial problem statement, identified factors and the plurality of hypotheses.

18. The method of formulating a problem of claim 17, further comprising performing exploratory data analysis (EDA) for generating the plurality of hypotheses.

19. The method of formulating a problem of claim 17, further comprising classifying the data elements and selecting data elements for the hypotheses based upon an estimated analytical effort and effectiveness of the data elements in solving the problem.

20. The method of formulating a problem of claim 17, further comprising analyzing the updated problem statement and developing action items to achieve the desired solution of the problem.
